(19) United States
(12) Patent Application Publication
(10) Pub. No.: US 2006/0285181 A1
(43) Pub. Date: Dec. 21, 2006

(54) PRINTING CONTROL SCALE, PRINTING SYSTEM AND PRINTING METHOD

(75) Inventor: Kazuki FUKUI, . (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD., Kyoto (JP)

(21) Appl. No.: 11/421,620

(22) Filed: Jun. 1, 2006

(30) Foreign Application Priority Data
Jun. 15, 2005 (JP) 2005-174670

(51) Int. Cl. H04N 1/46

(52) U.S. Cl. 358/504

(57) ABSTRACT

A printing control scale for use in printing in two or three color inks with a printing machine capable of multicolor printing using four color inks. The printing control scale includes two or three types of detecting patches printed in the two or three color inks. These detecting patches are arranged in positions respectively corresponding to four types of detecting patches printed when the four color inks are used. Regions printed in a combination of the two or three color inks are formed in positions corresponding to other detecting patches.

### BACKGROUND OF THE INVENTION

1. Field of the Invention

This invention relates to a printing control scale, a printing system and a printing method.

2. Description of the Related Art

When printing with an offset press or the like, as described in Japanese Unexamined Patent Publication No. 2004-358958, for example, a printing control scale is used to control ink feed rates and dampening water feed rates. This printing control scale includes a plurality of detecting patches such as solid patches and line patches arranged for each color ink.

FIG. 9 is an explanatory view showing such a conventional printing control scale.

When, for example, a four-color printing machine prints in four color inks of Y (yellow), M (magenta), C (cyan) and K (black), the machine uses a printing control scale having detecting patches corresponding to Y, M, C and K inks arranged in order as shown in FIG. 9A. A color value such as density of each detecting patch in this printing control scale is measured by a color value measuring device having a CCD camera, for example. The feed rate of each color ink and the feed rate of dampening water are controlled by using this color value.

In FIG. 9, the rectangles marked Y indicate detecting patches printed in Y ink, the rectangles marked M indicate detecting patches printed in M ink, the rectangles marked C indicate detecting patches printed in C ink, and the rectangles marked K indicate detecting patches printed in K ink.

When this four-color printing machine prints in three colors using the three color inks of Y, M and C, as shown in FIG. 9B, three types of detecting patches printed in Y ink, M ink and C ink are arranged in positions corresponding to the detecting patches of Y, M and C in the printing control scale used for printing in the four color inks shown in FIG. 9A.

Thus, the three types of detecting patches are arranged such that parts of the patches are spaced from each other. When measuring the density of the printing control scale with the color value measuring device, a flare occurs from an inkless region between adjacent detecting patches. The flare has an adverse influence whereby the densities of these adjacent detecting patches (i.e. the detecting patches of Y and C in this case) are detected lower than usual.

Such a problem arises particularly when an image pickup device having a line sensor is disposed in a direction of arrangement of the detecting patches, and unprinted regions are present in that direction.

In order to cope with such a problem, it is conceivable to arrange the three types of detecting patches printed in Y ink, M ink and C ink with no spacing as shown in FIG. 9C, instead of arranging these detecting patches in the positions corresponding to the detecting patches of Y, M and C in the printing control scale used for printing in the four color inks shown in FIG. 9A.

However, for a color value measuring device having a CCD camera or the like, it is necessary, generally, to perform calibrations such as a shading correction and a correction of density measurements. When the positions of the detecting patches of each color are changed, correction data will also be changed. It is therefore impossible to perform each correction effectively.

Thus, when the four-color printing machine prints in three colors using the three color inks of Y, M and C, the three types of detecting patches printed in Y ink, M ink and C ink must be arranged as shown in FIG. 9B, in positions corresponding to the detecting patches of Y, M and C in the printing control scale used for printing in the four color inks shown in FIG. 9A.

### SUMMARY OF THE INVENTION

The object of this invention, therefore, is to provide a printing control scale, a printing system and a printing method for enabling color values of detecting patches to be measured accurately even when a multicolor printing machine is used to print in the number of colors smaller than a printable number of colors.

The above object is fulfilled, according to this invention, by a printing control scale for use in printing in m color inks with a printing machine capable of multicolor printing using n color inks, where n is a natural number 2 or more and m is a natural number n−1 or less, the printing control scale comprising m types of detecting patches printed in the m color inks and arranged in positions respectively corresponding to n types of detecting patches printed when the n color inks are used; and regions printed in one of the m color inks or in a combination of at least two of the m color inks, in positions corresponding to detecting patches other than the m types of detecting patches.

With this printing control scale, regions printed in one of the m color inks or in a combination of at least two of the m color inks, in positions corresponding to detecting patches other than the m types of detecting patches. It is thus possible to measure color values of the detecting patches also when printing is performed with a smaller number of colors than the number of colors that can be printed with a multicolor printing machine.

In one preferred embodiment, regions printed in the combination of the m color inks are formed in the positions corresponding to the detecting patches other than the m types of detecting patches.

In a different preferred embodiment, the n color inks are yellow, magenta, cyan and black inks, the regions printed in a combination of the inks having dot percentages of 55 to 65% for the yellow ink, 40 to 50% for the magenta ink, 30 to 40% for the cyan ink, and 25 to 35% for the black ink.

In another aspect of the invention, a printing system is provided for printing in m color inks with a printing machine capable of multicolor printing using n color inks, where n is a natural number 2 or more and m is a natural number n−1 or less, the printing system comprising a platemaking device for forming an image of a printing control scale along with a subject image on m printing plates for printing in m colors such that, when printing in m colors, m types of detecting patches printed in the m color inks are arranged in positions respectively corresponding to n types of detecting patches printed when the n color inks are used, and regions printed in one of the m color inks or in a combination of at least two of the m color inks are arranged in positions corresponding to detecting patches other than the m types of detecting patches; a printing device for performing m-color printing by using uses the m printing plates created by the platemaking device; a color value measuring device for measuring color values of the printing control scale on a print made by the printing device; and a feed rate control device for controlling feed rates of the m color inks or dampening water by using the color values of the printing control scale measured by the color value measuring device.

In a further aspect of the invention, a printing method is provided for printing in m color inks with a printing machine capable of multicolor printing using n color inks, where n is a natural number 2 or more and m is a natural number n−1 or less, the method comprising a platemaking step for forming an image of a printing control scale along with a subject image on m printing plates for printing in m colors such that, when printing in m colors, m types of detecting patches printed in the m color inks are arranged in positions respectively corresponding to n types of detecting patches printed when the n color inks are used, and regions printed in one of the m color inks or in a combination of at least two of the m color inks are arranged in positions corresponding to detecting patches other than the m types of detecting patches; a printing step for performing m-color printing by using uses the m printing plates created in the platemaking step; a color value measuring step for measuring color values of the printing control scale on a print made in the printing step; and a feed rate control step for controlling feed rates of the m color inks or dampening water by using the color values of the printing control scale measured in the color value measuring step.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine according to this invention;

FIG. 2 is a schematic side view of an ink feeder;

FIG. 3 is a plan view of the ink feeder;

FIG. 4 is a schematic side view of a dampening water feeder;

FIG. 5 is a schematic side view showing an image pickup station along with a paper discharge mechanism such as a paper discharge cylinder;

FIG. 6 is a block diagram showing a principal electrical structure of this printing machine.

FIG. 7 is an explanatory view showing a sheet of printing paper having, printed thereon, a subject image and a printing control scale according to this invention;

FIG. 8 is an enlarged view showing parts of printing control scales; and

FIG. 9 is an explanatory view showing conventional printing control scales.

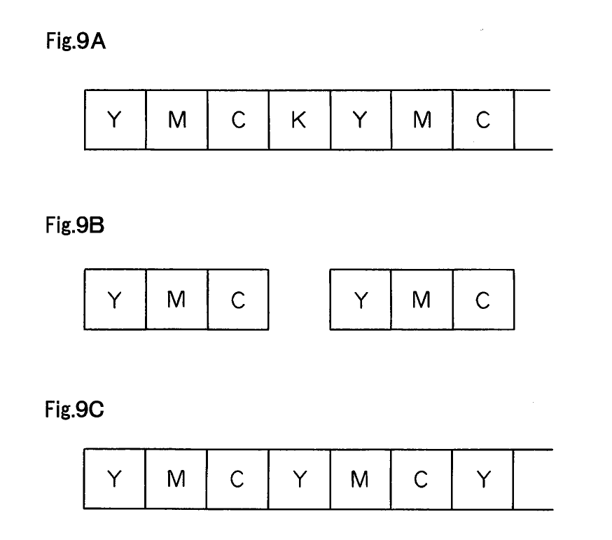

### DESCRIPTION OF THE PREFERRED EMBODIMENTS

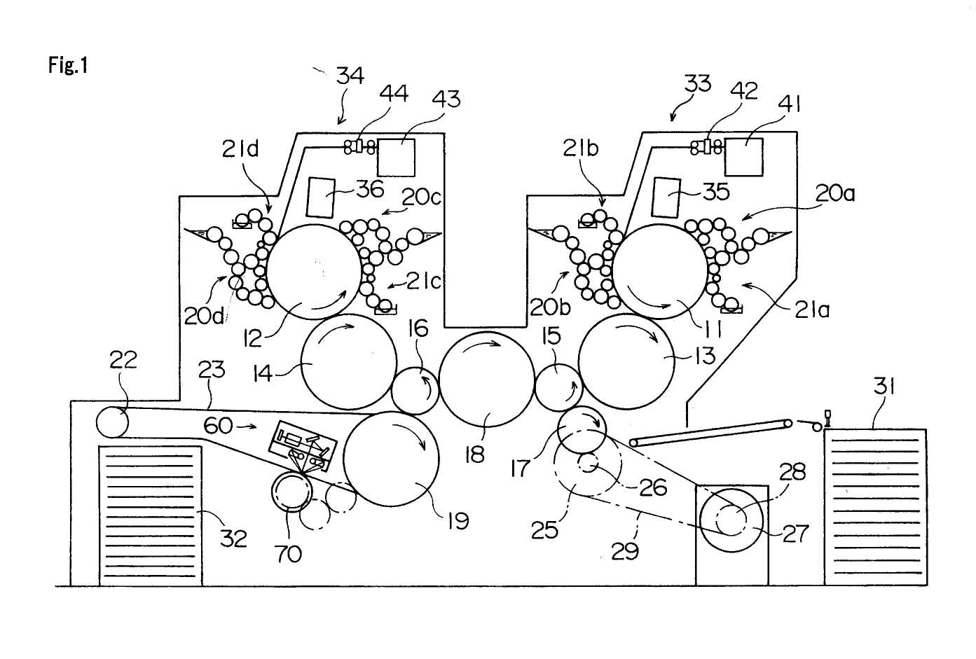

An embodiment of this invention will be described hereinafter with reference to the drawings. The construction of a printing machine according to this invention will be described first. FIG. 1 is a schematic view of the printing machine according to this invention.

This printing machine records images on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on a pair of sprockets 22 for discharging printed paper from the second impression cylinder 16 to a paper discharge station 32, and an image pickup station 60 for measuring densities of detecting patches printed on the printing paper.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the impression cylinder 15 has the same diameter as the first and second impression cylinders 15 and 16. The paper feed cylinder 17 has a gripper, not shown, for holding and transporting, with each intermittent rotation of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

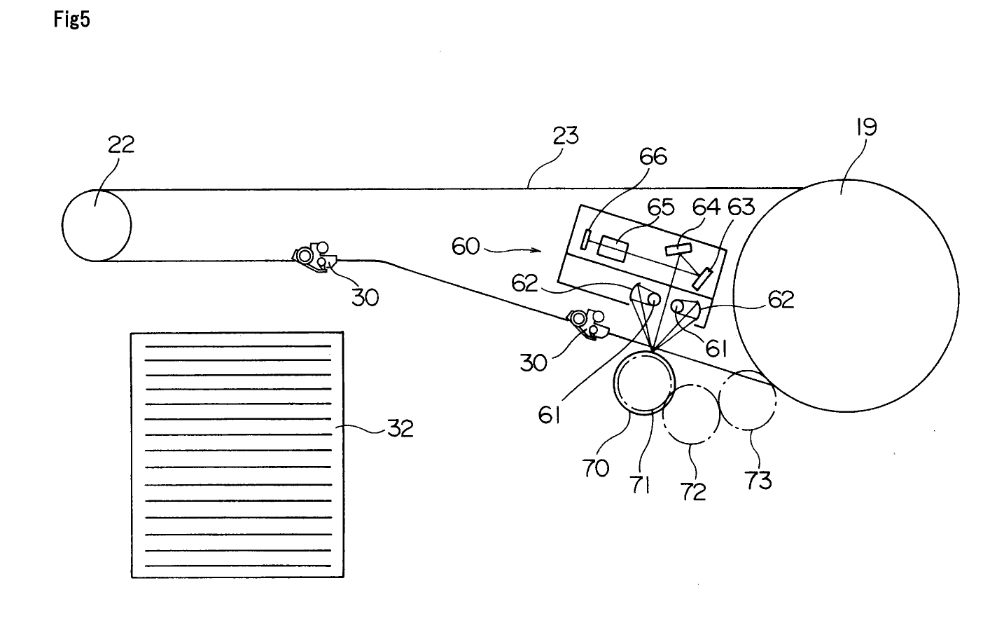

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having grippers 30 (FIG. 5) arranged thereon. When the second impression cylinder 16 transfers the printing paper to the discharge cylinder 19, one of the grippers 30 on the discharge cylinder 17 holds the forward end of the printing paper having been held by the gripper of the second impression cylinder 16. With movement of the chains 23, the printing paper is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

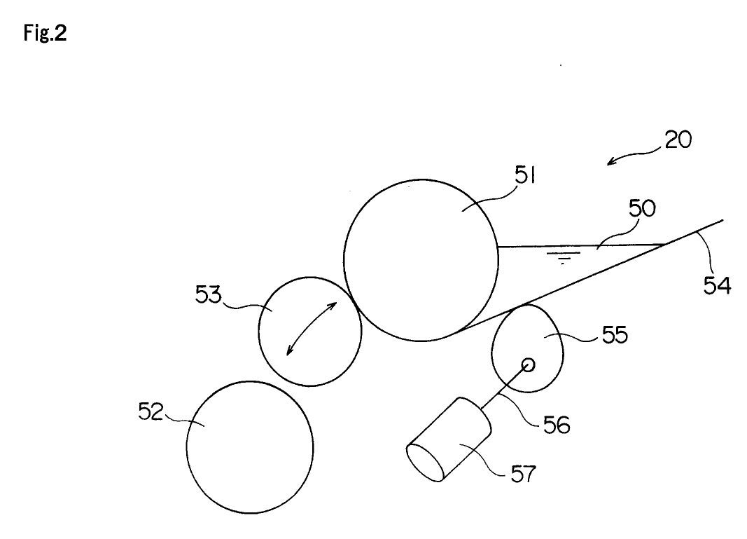

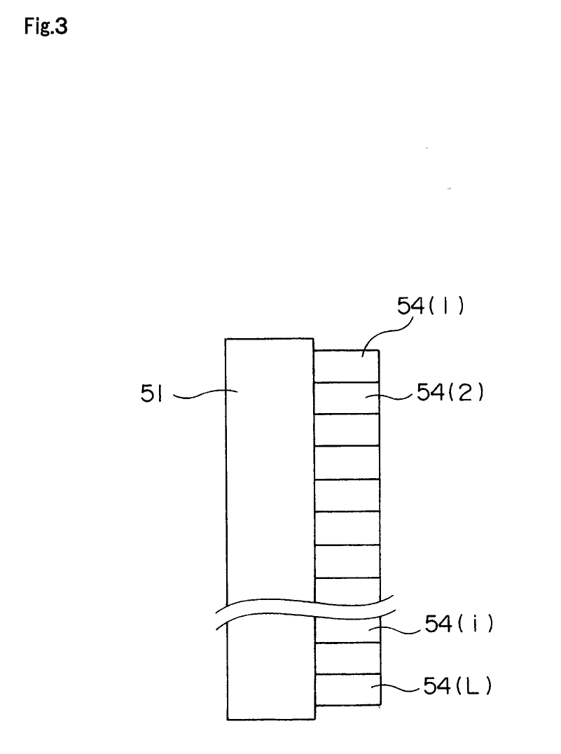

FIG. 2 is a schematic side view showing the ink feeder 20a among the above ink feeders 20a, 20b, 20c and 20d (which may be referred to collectively as “ink feeder 20”). FIG. 3 is a plan view thereof. Ink 50 is omitted from FIG. 3.

The ink feeder 20 includes an ink fountain roller 51 having an axis thereof extending in a direction of width of prints (i.e. perpendicular to a printing direction of the printing machine), and a plurality of ink rollers 52 (only one being shown in FIG. 2), and an ink transfer roller 53 that vibrates between the ink fountain roller 51 and a foremost one of the ink rollers 52. The ink feeder 20 further includes ink keys 54 (1), 54 (2) . . . 54 (L) (which may be referred to collectively as “ink keys 54”) arranged in the direction of width of the prints. The ink fountain roller 51 and ink keys 54 define an ink well for storing ink 50.

Eccentric cams 55, L in number, are arranged under the respective ink keys 54 for pressing the ink keys 54 toward the surface of ink fountain roller 51 to vary the opening degree of each ink key 54 with respect to the ink fountain roller 51. The eccentric cams 55 are connected through shafts 56 to pulse motors 57, L in number, for rotating the eccentric cams 55, respectively.

Each pulse motor 57, in response to an ink key drive pulse applied thereto, rotates the eccentric cam 55 about the shaft 56 to vary a pressure applied to the ink key 54. The opening degree of the ink key 54 with respect to the ink fountain roller 51 is thereby varied to vary the rate of ink fed to the printing plate.

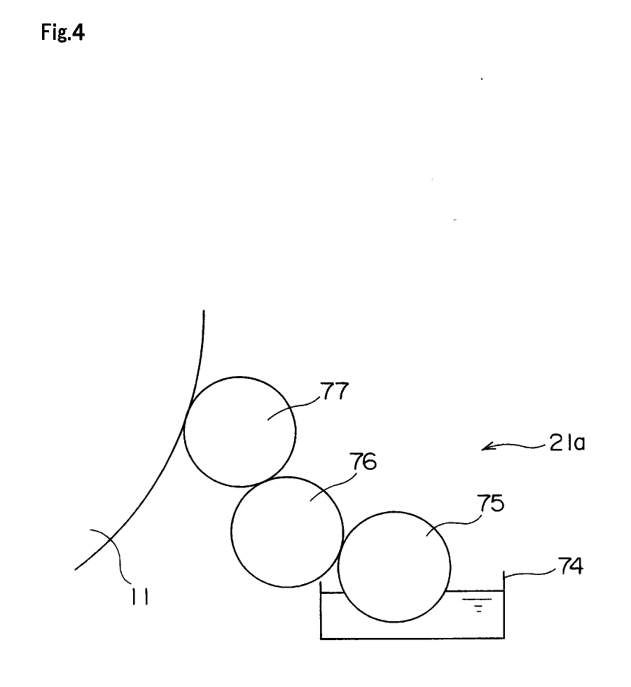

FIG. 4 is a schematic side view showing the dampening water feeder 21a among the above dampening water feeders 21a, 21b, 21c and 21d (which may be referred to collectively as “dampening water feeder 21”).

The dampening water feeder 21a includes a water source having a water vessel 74 for storing dampening water and a water fountain roller 75 rotatable by a motor 78, to be described hereinafter, and two water rollers 76 and 77 for transferring the dampening water from the fountain roller 75 to the surface of one of the plates mounted peripherally of the first plate cylinder 11. This dampening water feeder is capable of adjusting the feed rate of dampening water to the surface of the plate by varying the rotating rate of fountain roller 75.

FIG. 5 is a schematic side view showing the image pickup station 60 along with the paper discharge mechanism such as the paper discharge cylinder 19.

The image pickup station 60 is used to read images printed on the printing paper, and to measure density and the like of a printing control scale S according to this invention.

The pair of chains 23 are endlessly wound around the opposite ends of the paper discharge cylinder 19 and the pair of sprockets 22. As noted hereinbefore, the chains 23 are interconnected by coupling members, not shown, having a plurality of grippers 30 arranged thereon each for gripping the forward end of printing paper transported. FIG. 5 shows only two grippers 30, with the other grippers 30 omitted.

The pair of chains 23 have a length corresponding to a multiple of the circumference of first and second impression cylinders 15 and 16. The grippers 30 are arranged on the chains 23 at intervals each corresponding to the circumference of first and second impression cylinders 15 and 16. Each gripper 30 is opened and closed by a cam mechanism, not shown, synchronously with the gripper on the paper discharge cylinder 19. Thus, each gripper 30 receives the printing paper from the paper discharge cylinder 19, transports the printing paper with rotation of the chains 23, and is then opened by the cam mechanism, not shown, to discharge the paper on the paper discharge station 32.

The printing paper is transported with only the forward end thereof held by one of the grippers 30, the rear end of printing paper not being fixed. Consequently, the printing paper could flap during transport, which impairs an operation, to be described hereinafter, of the image pickup station 60 to read images and measure density of the printing control scale S. To avoid such an inconvenience, this printing machine provides a suction roller 70 disposed upstream of the paper discharge station 32 for stabilizing the printing paper transported.

The suction roller 70 is in the form of a hollow roller having a surface defining minute suction bores, with the hollow interior thereof connected to a vacuum pump not shown. The suction roller 70 has a gear 71 attached to an end thereof. The gear 71 is connected through idler gears 72 and 73 to the gear attached to an end of the paper discharge cylinder 19. Consequently, the suction roller 43 is driven to rotate in a matching relationship with a moving speed of the grippers 30. Thus, the printing paper is sucked to the surface of the suction roller 70, thereby being held against flapping when passing over the suction roller 70. In place of the suction roller 70, a suction plate may be used to suck the printing paper two-dimensionally.

The above image pickup station 60 includes a pair of linear light sources 61 extending parallel to the suction roller 70 for illuminating the printing paper on the suction roller 70, a pair of condensing plates 62, reflecting mirrors 63 and 64, a condensing lens 65 and a CCD line sensor 66. The detecting patches on the printing paper transported by the paper discharge mechanism including the paper discharge cylinder 19 and chains 23 are illuminated by the pair of linear light sources 61, and photographed by the CCD line sensor 66. This line sensor 66 is disposed to extend in a direction corresponding to a direction of arrangement of detecting patches described hereinafter (which is transverse to the printing paper and perpendicular to the transport direction of the printing paper).

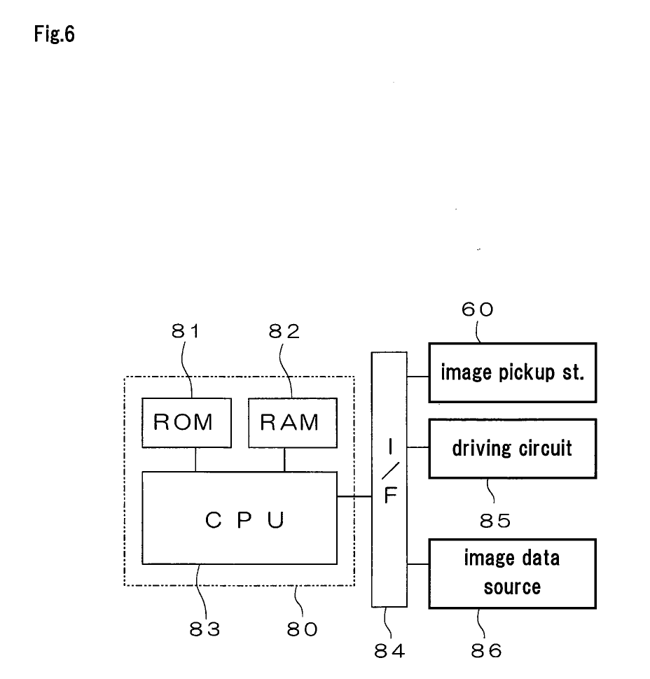

FIG. 6 is a block diagram showing a principal electrical structure of the printing machine.

This printing machine includes a control unit 80 having a ROM 81 for storing operating programs necessary for controlling the machine, a RAM 82 for temporarily storing data and the like during a control operation, and a CPU 83 for performing logic operations. The control unit 80 is connected to the image pickup station 60 through an interface 84. The control unit 80 is connected also to a driving circuit 85 through the interface 84 for generating driving signals for driving the ink feeders 20, dampening water feeders 21, image recorders 35 and 36 and so on. Further, the control unit 80 is connected through the interface 84 to an image data source 86 storing image data for use in platemaking and printing.

The printing machine, under control of the control unit 80, performs a prepress operation and a printing operation including ink and dampening water feeding operations to be described hereinafter.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at high speed, the image recorder 35 irradiates the surface of the plate mounted peripherally of the first plate cylinder 11 with a modulated laser beam for recording an image thereon. At this time, the printing control scale S described hereinafter is formed along with the subject image.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at low speed, the image recorder 36 irradiates the surface of the plate mounted peripherally of the second plate cylinder 12 with a modulated laser beam for recording an image thereon. At this time, the printing control scale S described hereinafter is formed along with the subject image.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon.

At this time, the printing paper being transported is illuminated by the pair of linear light sources 61, and are photographed by the CCD line sensor 66. That is, the density of printing control scale S described hereinafter is measured along with the subject image. Measurements of the density of printing control scale S are used to control the ink feed rate of each ink feeder 20 and the dampening water feed rate of each dampening water feeder 21 in a subsequent printing process.

After the printing process, the printing paper printed is discharged. The first and second blanket cylinders 13 and 14 are cleaned by a blanket cylinder cleaning device, not shown, to complete the printing process.

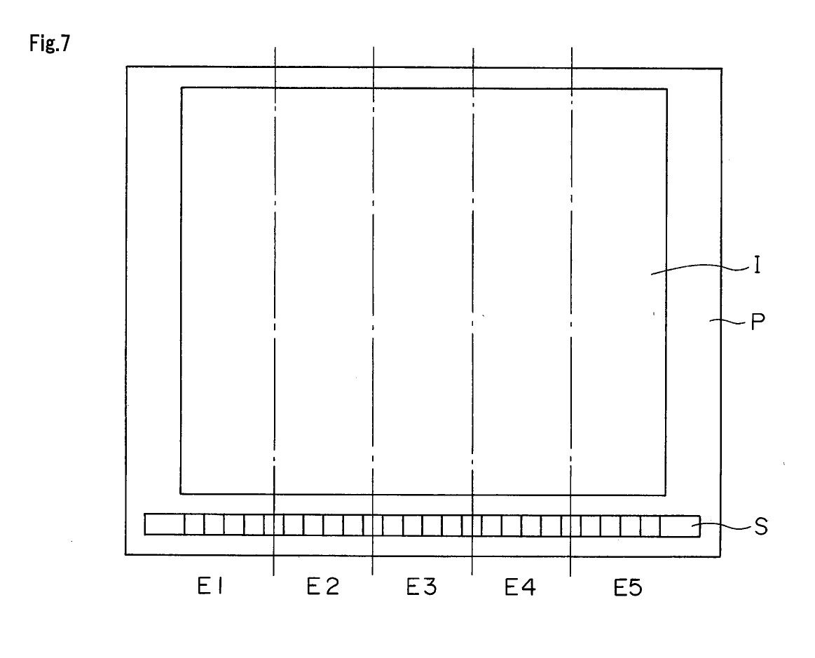

Next, the printing control scale S according to this invention will be described. FIG. 7 is an explanatory view showing a sheet of printing paper P having, printed thereon, a subject image and the printing control scale S according to this invention.

As noted above, when the image recorders 35 and 36 record images on the printing plates mounted peripherally of the first and second plate cylinders 11 and 12, the image of printing control scale S is formed along with a subject image I. Thus, printing paper P having been printed includes the subject image I and printing control scale S printed thereon. The printing control scale S has detecting patches of the colors Y, M, C and K arranged transversely of the printing paper, in regions E1-E5 corresponding to the respective ink keys in each ink feeder 20.

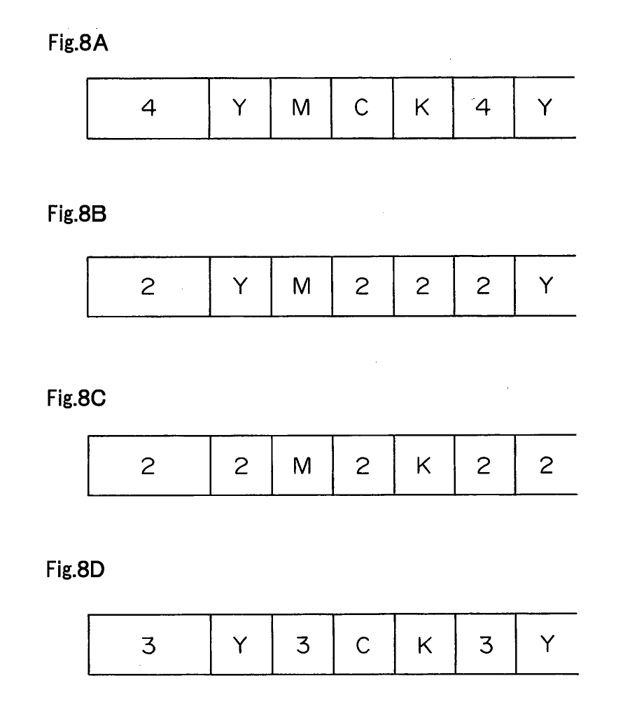

FIG. 8 is an enlarged view showing parts of printing control scales S.

In FIG. 8, the rectangles marked Y indicate detecting patches printed in Y ink, the rectangles marked M indicate detecting patches printed in M ink, the rectangles marked C indicate detecting patches printed in C ink, the rectangles marked K indicate detecting patches printed in K ink, the rectangles marked 2 indicate dummy patches printed in two color inks in superimposition, the rectangles marked 3 indicate dummy patches printed in three color inks in superimposition, and the rectangles marked 4 indicate dummy patches printed in four color inks in superimposition.

In this embodiment, the above dummy patches are patches whose densities are not measured, and are thus called “dummy” patches. However, these portions may be detecting patches for checking by density measurement or by visual observation.

Each of the above detecting patches may include a plurality of elements. For example, each detecting patch may be a combination of a solid patch and a plurality of line patches having different numbers of lines.

When the above printing machine performs four-color printing using the four color inks, the printing control scale S shown in FIG. 8A is used. In this printing control scale S, a detecting patch printed in Y ink, a detecting patch printed in M ink, a detecting patch printed in C ink and a detecting patch printed in K ink are arranged in each of the regions E1-E5 corresponding to the respective ink keys in each ink feeder 20. A dummy patch in gray is disposed in a position between each adjacent pair of regions E1-E5. These dummy patches are printed by combining the four color inks of Y, M, C and K or the three color inks of Y, M and C.

At opposite ends of the printing control scale S (opposite ends of the series of detecting patches), slightly large dummy patches in gray are disposed. These dummy patches also are printed by combining the four color inks of Y, M, C and K or the three color inks of Y, M and C. Flare can occur from inkless regions outwardly of the opposite ends of the printing control scale S. The large dummy patches serve to avoid the inconvenience of the densities of detecting patches (i.e. patches of Y in this case) adjacent the opposite ends being detected lower than usual under the influence of the flare.

Next, when this printing machine performs two-color printing using Y ink and M ink, the printing control scale S shown in FIG. 8B is used. In this printing control scale S, two types of detecting patches printed in Y ink and M ink are arranged in positions corresponding to the patches of the same colors among the four types of detecting patches used when printing in the four color inks shown in FIG. 8A. In positions corresponding to the detecting patches other than the two types of detecting patches of Y and M, dummy patches are formed by combining the two, Y and M, inks. That is, the dummy patches printed by combining Y and M inks are formed in positions corresponding to the detecting patches of C and K in the printing control scale S used in the four-color printing shown in FIG. 8A, as distinct from the prior art in which such positions are left blank.

A dummy patch is printed in a combination of Y and M inks in a position between each adjacent pair of regions E1-E5. Slightly large dummy patches are printed in the combination of Y and M inks at opposite ends of the printing control scale S.

When this printing machine performs two-color printing using M ink and K ink, the printing control scale S shown in FIG. 8C is used. In this printing control scale S, two types of detecting patches printed in M ink and K ink are arranged in positions corresponding to the patches of the same colors among the four types of detecting patches used when printing in the four color inks shown in FIG. 8A. In positions corresponding to the detecting patches other than the two types of detecting patches of M and K, dummy patches are formed by combining the two, M and K, inks. That is, the dummy patches printed by combining the M and K inks are formed in positions corresponding to the detecting patches of Y and C in the printing control scale used in the four-color printing shown in FIG. 8A, as distinct from the prior art in which such positions are left blank.

A dummy patch is printed in a combination of M and K inks in a position between each adjacent pair of regions E1-E5. Slightly large dummy patches are printed in the combination of M and K inks at opposite ends of the printing control scale S.

As noted hereinbefore, where part of the detecting patches are spaced from each other, a flare occurs from an inkless region between adjacent detecting patches, and exerts an adverse influence whereby the densities of these adjacent detecting patches are detected lower than usual. Where the printing control scale S shown in FIG. 8A or 8B is employed, it is possible to avoid such inconvenience effectively when the density of the printing control scale S is measured at the image pickup station 60.

In the printing control scale S shown in FIG. 8B or 8C, instead of using the dummy patches printed by combining two color inks, dummy patches may be printed in one of these inks. That is, the printing control scale S shown in FIG. 8B may have dummy patches of Y or M instead of the dummy patches printed by combining the two color inks. The printing control scale S shown in FIG. 8C may have dummy patches of M or K instead of the dummy patches printed by combining the two color inks. In this case also, it is possible to avoid the inconvenience of the densities of detecting patches adjacent the inkless regions being detected lower than usual under the influence of the flare occurring from the inkless region.

Further, when this printing machine performs three-color printing using Y ink, C ink and K ink, the printing control scale S shown in FIG. 8D is used. In this printing control scale S, three types of detecting patches printed in Y, C and K inks are arranged in positions corresponding to the patches of the same colors among the four types of detecting patches used when printing in the four color inks shown in FIG. 8A. In positions corresponding to the detecting patches (i.e. detecting patches of M) other than the three types of detecting patches, dummy patches are formed by combining the three, Y, C and K, inks. That is, the dummy patches printed by combining the Y, C and K inks are formed in positions corresponding to the detecting patches of M in the printing control scale used in the four-color printing shown in FIG. 8A, as distinct from the prior art in which such positions are left blank.

A dummy patch is printed in a combination of Y, C and K inks in a position between each adjacent pair of regions E1-E5. Slightly large dummy patches are printed in the combination of Y, C and K inks at opposite ends of the printing control scale S.

Also where the printing control scale S shown in FIG. 8D is employed, it is possible to avoid effectively the inconvenience of the densities of detecting patches adjacent the inkless regions being detected lower than usual when the density of the printing control scale S is measured at the image pickup station 60, under the influence of the flare occurring from the inkless region when part of the detecting patches are spaced from each other.

In the printing control scale S shown in FIG. 8D, instead of using the dummy patches printed by combining the three color inks, dummy patches may be printed in one or two of these inks. That is, instead of the dummy patches printed by combining the three color inks, dummy patches of Y, C or K may be used, or dummy patches may be printed in the two color inks of Y and C, C and K, or K and Y. In this case also, it is possible to avoid the inconvenience of the densities of detecting patches adjacent the inkless regions being detected lower than usual under the influence of the flare occurring from the inkless region.

In order to prevent the influence of flare effectively with the dummy patches printed in a plurality of inks in superimposition, dummy patches formed of each ink should have at least a predetermined density (dot percentage). Results of experiment conducted by Applicant show that an appropriate dot percentage of areas printed in a combination of inks is 20 to 30% or higher. Desirable percentages are 55 to 65% for Y ink, 40 to 50% for M ink, 30 to 40% for C ink, and 25 to 35% for K ink. To enhance the effect further, more desirable dot percentages are about 60% for Y ink, about 45% for M ink, about 35% for C ink, and about 30% for K ink.

In the printing machine described above, the image pickup station 60 measures the density of each detecting patch in the printing control scale S as a color value. However, color values other than density such as Lab may be used.

The printing machine described above performs four-color printing. The invention is applicable also to multicolor printing machines other than the four-color printing machine, such as a six-color printing machine.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2005-174670 filed in the Japanese Patent Office on Jun. 15, 2005, the entire disclosure of which is incorporated herein by reference.

What is claimed is:

1. A printing control scale for use in printing in m color inks with a printing machine capable of multicolor printing using n color inks, where n is a natural number 2 or more and m is a natural number n−1 or less, said printing control scale comprising:
m types of detecting patches printed in the m color inks and arranged in positions respectively corresponding to n types of detecting patches printed when the n color inks are used; and
regions printed in one of said m color inks or in a combination of at least two of said m color inks, in positions corresponding to detecting patches other than said m types of detecting patches.

2. A printing control scale as defined in claim 1, wherein regions printed in the combination of said m color inks are formed in the positions corresponding to the detecting patches other than said m types of detecting patches.

3. A printing control scale as defined in claim 1, wherein the n color inks are yellow, magenta, cyan and black inks, the regions printed in a combination of the inks having dot percentages of 55 to 65% for the yellow ink, 40 to 50% for the magenta ink, 30 to 40% for the cyan ink, and 25 to 35% for the black ink.

4. A printing system for printing in m color inks with a printing machine capable of multicolor printing using n color inks, where n is a natural number 2 or more and m is a natural number n−1 or less, said printing system comprising:
a platemaking device for forming an image of a printing control scale along with a subject image on m printing plates for printing in m colors such that, when printing in m colors, m types of detecting patches printed in the m color inks are arranged in positions respectively corresponding to n types of detecting patches printed when the n color inks are used, and regions printed in one of said m color inks or in a combination of at least two of said m color inks are arranged in positions corresponding to detecting patches other than said m types of detecting patches;
a printing device for performing m-color printing by using uses the m printing plates created by said platemaking device;
a color value measuring device for measuring color values of the printing control scale on a print made by said printing device; and
a feed rate control device for controlling feed rates of the m color inks or dampening water by using the color values of the printing control scale measured by said color value measuring device.

5. A printing system as defined in claim 4, wherein the n color inks are yellow, magenta, cyan and black inks, the regions printed in a combination of the inks having dot percentages of 55 to 65% for the yellow ink, 40 to 50% for the magenta ink, 30 to 40% for the cyan ink, and 25 to 35% for the black ink.

6. A printing system as defined in claim 4, wherein said color value measuring device has a line sensor extending in a direction corresponding to a direction of arrangement of said m types of detecting patches.

7. A printing method for printing in m color inks with a printing machine capable of multicolor printing using n color inks, where n is a natural number 2 or more and m is a natural number n−1 or less, said method comprising:
a platemaking step for forming an image of a printing control scale along with a subject image on m printing plates for printing in m colors such that, when printing in m colors, m types of detecting patches printed in the m color inks are arranged in positions respectively corresponding to n types of detecting patches printed when the n color inks are used, and regions printed in one of said m color inks or in a combination of at least two of said m color inks are arranged in positions corresponding to detecting patches other than said m types of detecting patches;
a printing step for performing m-color printing by using uses the m printing plates created in said platemaking step;
a color value measuring step for measuring color values of the printing control scale on a print made in said printing step; and
a feed rate control step for controlling feed rates of the m color inks or dampening water by using the color values of the printing control scale measured in said color value measuring step.

8. A printing method as defined in claim 7, wherein the n color inks are yellow, magenta, cyan and black inks, the regions printed in a combination of the inks having dot percentages of 55 to 65% for the yellow ink, 40 to 50% for the magenta ink, 30 to 40% for the cyan ink, and 25 to 35% for the black ink.

9. A printing method as defined in claim 7, wherein said color value measuring step is executed to measure the color values of the printing control scale with a line sensor extending in a direction corresponding to a direction of arrangement of said m types of detecting patches.
